(19) United States
(12) Patent Application Publication
(10) Pub. No.: US 2025/0037471 A1
(43) Pub. Date: Jan. 30, 2025

(54) SYSTEM AND METHOD FOR COLLECTING EQUIPMENT AND FACILITY DATA USING RPA

(71) Applicant: SIMPLATFORM CO., LTD, Seoul (KR)

(72) Inventor: Dae Geun LIM, Daejeon (KR)

(21) Appl. No.: 18/914,041

(22) Filed: Oct. 11, 2024

Related U.S. Application Data
(63) Continuation of application No. PCT/KR2023/003701, filed on Mar. 21, 2023.

(30) Foreign Application Priority Data
Apr. 12, 2022 (KR) 10-2022-0045034

(51) Int. Cl. G06V 20/52

(52) U.S. Cl. CPC G06V 20/52

(57) ABSTRACT

A process data collection system includes a monitoring image reception unit configured to receive image data output onto the screen of an equipment monitoring system; a monitoring data extraction unit configured to extract monitoring data for equipment by analyzing the received image data; and a monitoring data transmission unit configured to transmit the extracted monitoring data to a process analysis system over a communication network.

### CROSS-REFERENCE TO RELATED APPLICATIONS

This application is a Continuation of International Application No. PCT/KR2023/003701 filed Mar. 21, 2023, which claims priority from Korean Application No. 10-2022-0045034 filed Apr. 12, 2022. The aforementioned applications are incorporated herein by reference in their entireties.

### TECHNICAL FIELD

The present invention relates to equipment using robot process automation (RPA) and a facility data collection system and method, and more particularly to a system and method that can easily collect monitoring data even when it is difficult to receive data directly from process equipment and facilities or install a separate sensor.

### RELATED ART

With the development of artificial intelligence technology, the use of smart factory technology that collects process equipment and facility data and automatically manages the process is increasing. In order to collect and analyze process equipment data and manage a process through it, the status information of various types of equipment needs to be collected.

There are two main types of methods capable of collecting data from various types of equipment and facilities. A first method is to transmit monitoring data directly from the equipment over a network. To this end, the equipment needs to be connected to the network and have the function of transmitting monitoring data in a defined format. A second method is to install a separate sensor on equipment, monitor the status information of the equipment, and transmit generated monitoring data over a network.

However, the first method has a problem in that it is difficult to apply the first method to conventional equipment without such a monitoring data transmission function, and the second method has a problem in that the information that can be identified from equipment via an external sensor is limited.

Korean Patent No. 10-2093281 entitled “Method of Processing Process Data of Smart Factory,” which is a conventional art, is directed to the technology that collects process data generated from equipment and the process data of a factory via a sensor, matches the data, and performs analysis. Even when the conventional art is applied, the problems described above are not overcome, so that there is a demand for a method capable of collecting more accurate process data even from conventional equipment.

### SUMMARY

An object of the present invention is to collect monitoring data from the equipment and facilities that do not have the function of directly transmitting monitoring data.

An object of the present invention is to collect monitoring data without attaching a separate sensor to equipment and facilities.

An object of the present invention is to expand equipment and facilities from which monitoring data can be collected so that an overall process can be managed more effectively.

An object of the present invention is to extract the monitoring data of equipment by analyzing an image output onto the screen of a monitoring system attached to the equipment.

An object of the present invention is to extract monitoring data that needs to be additionally checked through a button operation in addition to the data output onto a current screen of in an equipment monitoring system.

An object of the present invention is to select a button required for extracting additional monitoring data by analyzing the buttons output onto the screen of an equipment monitoring system and operating it, thereby preventing interference with the operation of the monitoring system.

In order to accomplish the above object, a process data collection system according to an embodiment of the present invention may be configured to include: a monitoring image reception unit configured to receive image data output onto the screen of an equipment monitoring system; a monitoring data extraction unit configured to extract monitoring data for equipment by analyzing the received image data; and a monitoring data transmission unit configured to transmit the extracted monitoring data to a process analysis system over a communication network.

In this case, the monitoring data extraction unit may analyze the received image data to identify a monitoring operation button area and a monitoring data display area, may recognize an image displayed in the monitoring data display area as characters to extract monitoring data, may analyze the monitoring operation button area to generate an operation command, and may transmit the operation command to the monitoring system.

Furthermore, the monitoring data extraction unit may transmit the operation command to the monitoring system, and may repeat the operation of checking whether the image data has changed and extracting monitoring data when the image data has changed.

Furthermore, the monitoring data extraction unit may analyze the image displayed in the monitoring data display area to identify a character indicative of a type of data and a character indicative of the data, and may extract monitoring data by associating the character indicative of the type of data and the character indicative of the data with each other.

Moreover, the monitoring data extraction unit may identify a character or an image representative of each operation button in the operation button area, and may analyze a meaning represented by the identified character or image to determine whether to generate an operation command for the operation button area.

The present invention has the effect of collecting monitoring data from the equipment and facilities that do not have the function of directly transmitting monitoring data.

The present invention has the effect of collecting monitoring data without attaching a separate sensor to equipment and facilities.

The present invention has the effect of expanding equipment and facilities from which monitoring data can be collected so that an overall process can be managed more effectively.

The present invention has the effect of extracting the monitoring data of equipment by analyzing an image output onto the screen of the monitoring system attached to the equipment.

The present invention has the effect of extracting monitoring data that needs to be additionally checked through a button operation in addition to the data output onto a current screen of in the equipment monitoring system.

The present invention has the effect of selecting a button required for extracting additional monitoring data by analyzing the buttons output onto the screen of the equipment monitoring system and operating it, thereby preventing interference with the operation of the monitoring system.

### BRIEF DESCRIPTION OF THE DRAWINGS

FIG. 1 is a block diagram showing the internal configuration of a process data collection system according to an embodiment of the present invention;

FIG. 2 is a diagram showing an example of analyzing image data output onto the screen of the equipment monitoring system of the present invention;

FIG. 3 is a diagram showing an example of extracting additional monitoring data through a button operation in the equipment monitoring system of the present invention; and

FIG. 4 is a flowchart showing the flow of a process data collection method according to an embodiment of the present invention.

### DETAILED DESCRIPTION

In order to accomplish the above object, a process data collection system according to an embodiment of the present invention may be configured to include: a monitoring image reception unit configured to receive image data output onto the screen of an equipment monitoring system; a monitoring data extraction unit configured to extract monitoring data for equipment by analyzing the received image data; and a monitoring data transmission unit configured to transmit the extracted monitoring data to a process analysis system over a communication network.

In this case, the monitoring data extraction unit may analyze the received image data to identify a monitoring operation button area and a monitoring data display area, may recognize an image displayed in the monitoring data display area as characters to extract monitoring data, may analyze the monitoring operation button area to generate an operation command, and may transmit the operation command to the monitoring system.

Furthermore, the monitoring data extraction unit may transmit the operation command to the monitoring system, and may repeat the operation of checking whether the image data has changed and extracting monitoring data when the image data has changed.

Furthermore, the monitoring data extraction unit may analyze the image displayed in the monitoring data display area to identify a character indicative of a type of data and a character indicative of the data, and may extract monitoring data by associating the character indicative of the type of data and the character indicative of the data with each other.

Moreover, the monitoring data extraction unit may identify a character or an image representative of each operation button in the operation button area, and may analyze a meaning represented by the identified character or image to determine whether to generate an operation command for the operation button area.

Hereinafter, preferred embodiments of the present invention will be described in detail with reference to the accompanying drawings. In the description of the present invention, when it is determined that a detailed description of a related known configuration or function may obscure the gist of the present invention, the detailed description will be omitted. Furthermore, in the description of the embodiments of the present invention, specific numerical values are merely examples, and the scope of the invention is not limited thereby.

A process data extraction system according to the present invention may be configured in the form of a server equipped with a central processing unit (CPU) and memory (a storage device) and capable of being connected to another terminal over a communication network such as the Internet. However, the present invention is not limited by the configurations of the central processing unit and the memory. Furthermore, the process data extraction system according to the present invention may be configured as a physically single apparatus, or may be implemented in a distributed form across a plurality of apparatuses.

In the present invention, the process may refer to a production or manufacturing process that produces products by using equipment and facilities, or may refer to various cases of maintaining and operating equipment or facilities. Furthermore, the part described as equipment in the claims of the present application and/or the like may be interpreted to mean various automated things such as equipment, facilities, and/or the like.

In the present invention, RPA technology may be utilized to analyze and control the screen of an equipment monitoring system. RPA technology stands for Robot Process Automation, which means that a software robot performs repetitive tasks instead. Through this, various types of information displayed on the screen of the monitoring system may be collected, and the monitoring system may be operated.

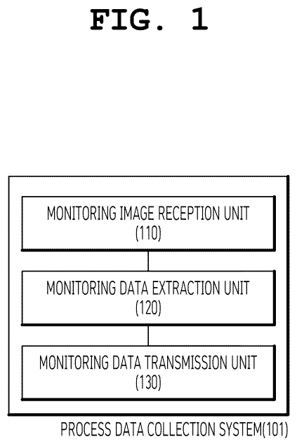

FIG. 1 is a block diagram showing the internal configuration of a process data collection system according to an embodiment of the present invention.

As shown in the drawing, a process data collection system 101 according to an embodiment of the present invention may be configured to include a monitoring image reception unit 110, a monitoring data extraction unit 120, and a monitoring data transmission unit 130. The individual components may be software modules operating within a physically identical computer system, and may be configured to allow two or more physically separated computer systems to operate in conjunction with each other. Various embodiments including the same functions fall within the scope of the present invention.

The monitoring image reception unit 110 receives the image data output onto the screen of an equipment monitoring system. The equipment monitoring equipment is the equipment that is attached to equipment and can monitor the status of the equipment. The equipment monitoring equipment may be configured to be generally installed in the form of software on a PC, to be connected to the equipment via a separate cable or the like, and to output the status information of the equipment onto the screen.

The image data received by the monitoring image reception unit 110 is an image output onto the display screen of the monitoring system. In order to receive such an image, the monitoring image reception unit 110 may be configured to be installed as software in the monitoring system and capture a screen. The screen output in real time may be captured to generate video data, and a function for encoding using various video codecs may be included for the efficient transmission of the video data.

The monitoring data extraction unit 120 extracts monitoring data for the equipment by analyzing the received image data. As described above, the image data is the data obtained by capturing an image that is used to output the status information of the equipment onto the display screen in the equipment monitoring system. The status information of the equipment is included inside the image data, and thus, the monitoring data can be extracted by analyzing the image data.

In order to enable the continuous monitoring of the equipment status, the monitoring data extraction unit 120 may periodically extract monitoring data by periodically analyzing the received image data. The period at which data is extracted may be set differently depending on the characteristics of the equipment or the like.

The image data received from the monitoring data extraction unit 120 may include status information in various forms depending on the equipment. Accordingly, a user for analysis may directly input information about information to be output and the location at which the information is output in the equipment monitoring system, and data may be extracted based on the information.

Furthermore, the monitoring data extraction unit 120 may analyze what information is included in the image data using artificial intelligence technology without a user having to directly set the location at which necessary data is displayed, and may extract monitoring data as a result. To this end, training data may be constructed for the monitoring system screens of various pieces of equipment, and an artificial intelligence model may be trained through the training data.

The monitoring data extraction unit 120 analyzes the received image data to identify a monitoring operation button area and a monitoring data display area, recognizes the image displayed in the monitoring data display area as characters to extract monitoring data, analyzes the monitoring operation button area to generate an operation command, and transmits the operation command to the monitoring system.

The screen of the equipment monitoring system may include various buttons configured to enable the user to view not only equipment status information but also necessary status information. The monitoring data extraction unit 120 may divide the image data into a monitoring data output area and a monitoring operation button area in order to extract necessary information. The monitoring operation button area may be a button for changing output monitoring data and may be configured to be operated by mouse click or touch.

The monitoring data extraction unit 120 transmits an operation command to the monitoring system, and repeats the operation of checking whether image data has changed and extracting monitoring data when the image data has changed. As described above, when a mouse click or touch operation is performed on the monitoring operation button area, the operation of the corresponding button may be performed. When an operation command to provide notification that a mouse click or touch operation event has occurred for the coordinates where the monitoring operation button area of the monitoring system is located is generated using the above method, the operation of the corresponding button may be performed. Through this, not only the monitoring data currently displayed on the screen, but also the monitoring data that needs to be checked by moving the screen through the button operation may be extracted.

The monitoring data extraction unit 120 analyzes the image displayed in the monitoring data display area to identify a character indicative of the type of data and a character indicative of the data, and extracts monitoring data by associating the character indicative of the type of data and the character indicative of the data with each other. In the area where the monitoring data is output, information about the item (voltage, current, temperature, humidity, or the like) of data and information about the unit of the corresponding data may generally be displayed, and the corresponding data may be displayed via a number, and/or the like. Accordingly, it may be possible to distinguish and recognize these types of information and to associate and extract the item of data and the value of the data.

In order to identify the necessary character information in this manner in the monitoring data extraction unit 120, various character recognition technologies (OCR technologies) may be applied, and the present invention is not limited by the type of such technology.

The monitoring data extraction unit 120 identifies a character or an image representative of each operation button in the operation button area, and determines whether to generate an operation command for the operation button area by analyzing the meaning of the identified character or image.

In the case where among the buttons displayed on the screen of the equipment monitoring system, there is a button for terminating the monitoring system itself or operating the equipment, when an operation command for the corresponding button is generated, there may occur a case where the operation of the equipment is interrupted or monitoring itself becomes impossible.

Accordingly, the monitoring data extraction unit 120 needs to identify the button that should be operated to extract another type of monitoring data and the button that should not be operated, among the buttons displayed on the screen of the monitoring system. To this end, the monitoring data extraction unit 120 may select the button that should be operated by identifying and analyzing characters or images marked on the buttons or areas above/below the buttons.

The monitoring data transmission unit 130 transmits the extracted monitoring data to a process analysis system over a communication network. As described above, the extracted monitoring data may be in the form in which information about the item of data, information about the unit of the data, and data are associated with one another. When this monitoring data is transmitted to the process analysis system, the process analysis system may check the status of the process by analyzing the monitoring data.

The process analysis system, to which the monitoring data is transmitted from the monitoring data transmission unit 130, may analyze the status of the process by using artificial intelligence (AI) technology and/or the like, and may derive the presence/absence of an abnormality in each piece of equipment, a process control method for efficient operation, and/or the like.

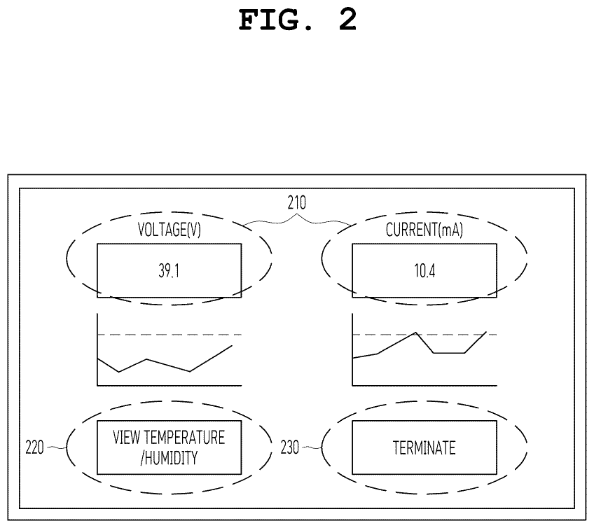

FIG. 2 is a diagram showing an example of analyzing image data output onto the screen of the equipment monitoring system of the present invention.

As shown in the drawing, the screen of the equipment monitoring system may include an area 210 where data indicative of the status of the equipment is output and operation button areas 220 and 230 where operable buttons are located.

The monitoring data display area 210 may contain information about the item to which each piece of data is directed and information about the unit in which the data is displayed, and may display data for each item in the form of a number, a character, or the like. When this information is extracted and collected, the process data that can be used to identify the status of the equipment may be generated.

Furthermore, as indicated by the reference symbol 220, there may be a button that is used to move the screen to extract another type of monitoring data. Furthermore, as indicated by the reference symbol 230, there may be a button that should not be operated during the process of collecting process data, such as a button for terminating the monitoring system itself or operating the equipment.

In the present invention, the meaning of each button may be analyzed by analyzing the image output onto the screen of the monitoring system, the button that should be operated to collect another type of monitoring data and the button that should not be operated may be identified through the above operation, and an operation command for the button that should be operated may be generated.

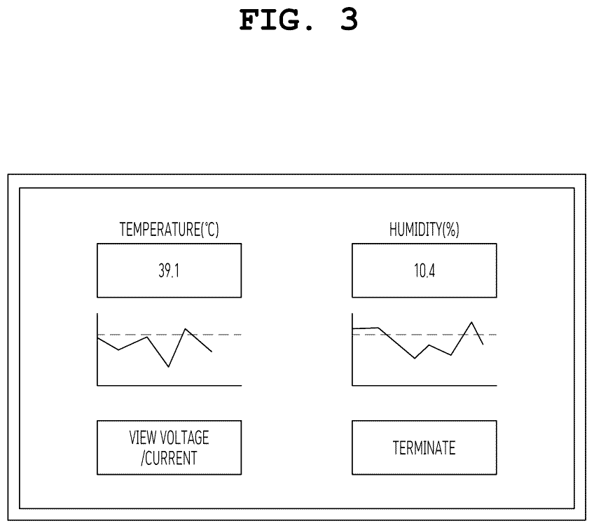

FIG. 3 is a diagram showing an example of extracting additional monitoring data through a button operation in the equipment monitoring system of the present invention.

In the case where an operation command is generated for the “View Temperature/Humidity” button indicated by the reference symbol 220 in FIG. 2 and transmitted to the equipment monitoring system, the corresponding button may be operated to display temperature and humidity information as shown in FIG. 3.

Even in the case where it is difficult to output all monitoring data onto a single screen, and thus, monitoring data needs to be collected by moving the screen through a button operation, the process data collection system 101 of the present invention may perform the operation of sufficiently extracting necessary data.

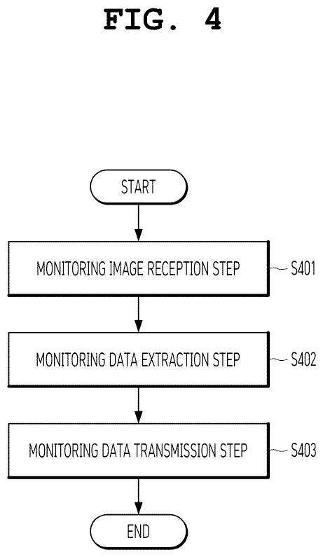

FIG. 4 is a flowchart showing the flow of a process data collection method according to an embodiment of the present invention.

The process data collection method according to the present invention is a process data collection method that operates in the process data collection system 101 equipped with a central processing unit and memory, and may be executed in such a computing system.

Accordingly, the process data collection method includes all the characteristic configurations described for the above-described process data collection system 101, and the items that are not described in the following description may also be implemented by referring to the descriptions given for the above-described process data collection system.

In a monitoring image reception step S401, the image data output onto the screen of the equipment monitoring system is received. The equipment monitoring equipment is the equipment that is attached to equipment and can monitor the status of the equipment. The equipment monitoring equipment may be configured to be generally installed in the form of software on a PC, to be connected to the equipment via a separate cable or the like, and to output the status information of the equipment onto the screen.

The image data received in the monitoring image reception step S401 is an image output onto the display screen of the monitoring system. In order to receive such an image, the monitoring image reception step S401 may be configured to be installed as software in the monitoring system and capture a screen. The screen output in real time may be captured to generate video data, and a function for encoding using various video codecs may be included for the efficient transmission of the video data.

In the monitoring data extraction step S402, monitoring data for the equipment is extracted by analyzing the received image data. As described above, the image data is the data obtained by capturing an image that is used to output the status information of the equipment onto the display screen in the equipment monitoring system. Accordingly, the status information of the equipment is included inside the image data, and thus, the monitoring data can be extracted by analyzing the image data.

In order to enable the continuous monitoring of the equipment status, in the monitoring data extraction step S402, monitoring data may be periodically extracted by periodically analyzing the received image data. The period at which data is extracted may be set differently depending on the characteristics of the equipment or the like.

The image data received in the monitoring data extraction step S402 may include status information in various forms depending on the equipment. Accordingly, a user for analysis may directly input information about information to be output and the location at which the information is output in the equipment monitoring system, and data may be extracted based on the information.

Furthermore, in the monitoring data extraction step S402, what information is included in the image data may be analyzed using artificial intelligence technology without a user having to directly set the location at which necessary data is displayed, and monitoring data may be extracted as a result. To this end, training data may be constructed for the monitoring system screens of various pieces of equipment, and an artificial intelligence model may be trained through the training data.

In the monitoring data extraction step S402, the received image data is analyzed to identify a monitoring operation button area and a monitoring data display area, the image displayed in the monitoring data display area is recognized as characters to extract monitoring data, the monitoring operation button area is analyzed to generate an operation command, and the operation command is transmitted to the monitoring system.

The screen of the equipment monitoring system may include various buttons configured to enable the user to view not only equipment status information but also necessary status information. In the monitoring data extraction step S402, the image data may be divided into a monitoring data output area and a monitoring operation button area in order to extract necessary information. The monitoring operation button area may be a button for changing output monitoring data and may be configured to be operated by mouse click or touch.

In the monitoring data extraction step S402, an operation command is transmitted to the monitoring system, and the operation of checking whether image data has changed and extracting monitoring data when the image data has changed is repeated. As described above, when a mouse click or touch operation is performed on the monitoring operation button area, the operation of the corresponding button may be performed. When an operation command to provide notification that a mouse click or touch operation event has occurred for the coordinates where the monitoring operation button area of the monitoring system is located is generated using the above method, the operation of the corresponding button may be performed. Through this, not only the monitoring data currently displayed on the screen, but also the monitoring data that needs to be checked by moving the screen through the button operation may be extracted.

In the monitoring data extraction step S402, the image displayed in the monitoring data display area is analyzed to identify a character indicative of the type of data and a character indicative of the data, and monitoring data I extracted by associating the characters indicative of the type of data and the characters indicative of the data with each other. In the area where the monitoring data is output, information about the item (voltage, current, temperature, humidity, or the like) of data and information about the unit of the corresponding data may generally be displayed, and the corresponding data may be displayed via a number, and/or the like. Accordingly, it may be possible to distinguish and recognize these types of information and to associate and extract the item of data and the value of the data.

In order to identify the necessary character information in this manner in the monitoring data extraction step S402, various character recognition technologies (OCR technologies) may be applied, and the present invention is not limited by the type of such technology.

In the monitoring data extraction step S402, a character or an image representative of each operation button in the operation button area is identified, and whether to generate an operation command for the operation button area is determined by analyzing the meaning of the identified character or image.

In the case where among the buttons displayed on the screen of the equipment monitoring system, there is a button for terminating the monitoring system itself or operating the equipment, when an operation command for the corresponding button is generated, there may occur a case where the operation of the equipment is interrupted or monitoring itself becomes impossible.

Accordingly, in the monitoring data extraction step S402, it is necessary to identify the button that should be operated to extract another type of monitoring data and the button that should not be operated, among the buttons displayed on the screen of the monitoring system. To this end, the button that should be operated may be selected by identifying and analyzing characters or images marked on the buttons or areas above/below the buttons.

In a monitoring data transmission step S403, the extracted monitoring data is transmitted to a process analysis system over a communication network. As described above, the extracted monitoring data may be in the form in which information about the item of data, information about the unit of the data, and data are associated with one another. When this monitoring data is transmitted to the process analysis system, the process analysis system may check the status of the process by analyzing the monitoring data.

The process analysis system, to which the monitoring data is transmitted in the monitoring data transmission step S403, may analyze the status of the process by using artificial intelligence (AI) technology and/or the like, and may derive the presence/absence of an abnormality in each piece of equipment, a process control method for efficient operation, and/or the like.

The process data collection method according to the present invention may be implemented as a program to be executed by a computer, and may be recorded on a computer-readable storage medium.

Examples of the computer-readable storage medium include magnetic media such as hard disks, floppy disks and magnetic tapes, optical storage media such as CDROMs and DVDs, magneto-optical media such as floptical disks, and hardware devices specially configured to store and execute program instructions, such as ROM, RAM, flash memory, and the like.

Examples of the program instructions include high-level language codes that can be executed by a computer using an interpreter or the like as well as machine language codes such as those produced by a compiler. Each of the hardware devices may be configured to act as one or more software modules to perform processing according to the present invention, and vice versa.

Although the present invention has been described with reference to the embodiments, those skilled in the art may variously modify and change the present invention without departing from the spirit and scope of the present invention described in the attached claims.

### INDUSTRIAL APPLICABILITY

The present invention is directed to a process data collection system and method. There are provided a process data collection system including: a monitoring image reception unit configured to receive image data output onto the screen of an equipment monitoring system; a monitoring data extraction unit configured to extract monitoring data for equipment by analyzing the received image data; and a monitoring data transmission unit configured to transmit the extracted monitoring data to a process analysis system over a communication network, and a method of operating the same.

What is claimed is:

1. A process data collection system, comprising:
a monitoring image reception unit configured to receive image data output onto a screen of an equipment monitoring system;
a monitoring data extraction unit configured to extract monitoring data for equipment by analyzing the received image data; and
a monitoring data transmission unit configured to transmit the extracted monitoring data to a process analysis system over a communication network.

2. The process data collection system of claim 1, wherein the monitoring data extraction unit:
analyzes the received image data to identify a monitoring operation button area and a monitoring data display area;
recognizes an image displayed in the monitoring data display area as characters to extract monitoring data;
analyzes the monitoring operation button area to generate an operation command; and
transmits the operation command to the monitoring system.

3. The process data collection system of claim 2, wherein the monitoring data extraction unit transmits the operation command to the monitoring system, and repeats an operation of checking whether the image data has changed and extracting monitoring data when the image data has changed.

4. The process data collection system of claim 3, wherein the monitoring data extraction unit:
analyzes the image displayed in the monitoring data display area to identify a character indicative of a type of data and a character indicative of the data; and
extracts monitoring data by associating the character indicative of the type of data and the character indicative of the data with each other.

5. The process data collection system of claim 4, wherein the monitoring data extraction unit:
identifies a character or an image representative of each operation button in the operation button area; and
analyzes a meaning represented by the identified character or image to determine whether to generate an operation command for the operation button area.

6. A process data collection method that operates in a process data collection system equipped with a central processing unit and memory, the process data collection method comprising:
a monitoring image reception step of receiving image data output onto a screen of an equipment monitoring system;
a monitoring data extraction step of extracting monitoring data for equipment by analyzing the received image data; and
a monitoring data transmission step of transmitting the extracted monitoring data to a process analysis system over a communication network.

7. The process data collection method of claim 6, wherein the monitoring data extraction step comprises:
analyzing the received image data to identify a monitoring operation button area and a monitoring data display area;
recognizing an image displayed in the monitoring data display area as characters to extract monitoring data;
analyzing the monitoring operation button area to generate an operation command; and
transmitting the operation command to the monitoring system.

8. The process data collection method of claim 7, wherein the monitoring data extraction step comprises transmitting the operation command to the monitoring system and repeating an operation of checking whether the image data has changed and extracting monitoring data when the image data has changed.

9. The process data collection method of claim 8, wherein the monitoring data extraction step comprises:
analyzing the image displayed in the monitoring data display area to identify a character indicative of a type of data and a character indicative of the data; and
extracting monitoring data by associating the character indicative of the type of data and the character indicative of the data with each other.

10. The process data collection method of claim 9, wherein the monitoring data extraction step comprises:
identifying a character or an image representative of each operation button in the operation button area; and
analyzing a meaning represented by the identified character or image to determine whether to generate an operation command for the operation button area.

11. A non-transitory computer-readable storage medium having recorded thereon a program for causing a computer to execute the method of claim 6.
